(19) United States
(12) Patent Application Publication
(10) Pub. No.: US 2005/0190791 A1
(43) Pub. Date: Sep. 1, 2005

(54) Switching matrix for software radio

(76) Inventor: Brig Barnum Elliott, Arlington, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 10/786,328

(22) Filed: Feb. 26, 2004

(51) Int. Cl. H04M 3/00

(52) U.S. Cl. 370/467; 370/480

(57) ABSTRACT

Systems and methods are provided for connecting a software radio to an antenna. The system includes a group of radio components [302-1, 302-2, 302-3, 302-4, 304, 306, 308, and 310] and a packetized switch [303]. Some of the radio components are connected to at least some other of the radio components via the packetized switch, such that a collection of connected ones of the radio components forms a complete software radio. A management station [312] may be provided for monitoring, controlling and configuring the radio components [302-1, 302-2, 302-3, 302-4, 304, 306, 308, and 310].

### RELATED APPLICATION

This application is related to U.S. patent application Ser. No. 10/039,621, entitled, “RADIO WITH INTERNAL PACKET NETWORK,” filed on Oct. 24, 2001 and herein incorporated by reference in its entirety.

### TECHNICAL FIELD

The invention relates to the field of software radios, and more particularly to methods and systems for connecting a software radio to one of a number of radio antennas.

### BACKGROUND OF THE INVENTION

FIG. 1 shows a high level schematic of an exemplary software radio 100. Software radio 100 may include a red processor component 102, a crypto component 104, a black processor component 106, and a black radio component 108 having a connection to an antenna 110. In an existing software radio, each of the components or modules may be connected by a Peripheral Component Interface (PCI) bus or similar form of equipment bus.

Red processor component 102 may include software running on a microcontroller that performs routing functions, management functions, and other functions.

Crypto component 104 may include one or more cryptologic devices that perform encryption, decryption, authentication and other services.

Black processor 106 may include software running on a microcontroller that performs lower-level routing functions, framing, conversion to appropriate waveform representations, testing of radio services, and other services.

Black radio 108 may perform actual radio transmission and reception and may include a number of subcomponents, including, but not limited to one or more modems, transmit/receive chains, power amplifiers, filters and tunable multicouplers.

FIG. 2 illustrates a well-known way in which one may organize such software radios to implement a “radio room” on for example, a Navy ship or land facility. In FIG. 2, red processor component 102′, crypto component 104′, black processor component 106′ and black radio component 108′ form one software radio, red processor component 102″, crypto component 104″, black processor component 106″ and black radio component 108″ form a second software radio, and red processor component 102′″, crypto component 104′″, black processor component 106′″ and black radio component 108′″ form another software radio. Each of the software radios may be connected to an RF switch 202 via, for example, a cable from one of the software radio components, such as black radio 108′, 108″, and 108′″ to RF switch 202. The switch may connect any of the radios to any of antennas 204-1, 204-2, 204-3, 204-4, 205-5 and 205-6. In FIG. 2, the software radio formed by components 102′, 104′, 106′ and 108′ is connected to antenna 204-3 via RF switch 202, as indicated by the thick lines.

One drawback to using an RF switch is that it can be quite bulky and very expensive, particularly if the RF switch must work across a wide range of frequencies, for example, from 2 MHz to 2 GHz. Further, because the RF switch is an analog switch, it may introduce loss, noise, or degradation into the signal, which is highly undesirable. Therefore, a cheaper, less bulky method for connecting a group of software radios to a group of antennas, in a way that experiences little or no signal loss in the interconnecting switch, is highly desirable.

### SUMMARY OF THE INVENTION

Systems and methods are provided for connecting software radios to a number of radio antennas.

In a first aspect of the invention, a system is provided. The system includes a group of radio components and a packetized switch. Some of the radio components are connected to at least some other of the radio components via the packetized switch, such that a collection of connected ones of the radio components forms a complete software radio.

In a second aspect of the invention, a method of connecting components of a software radio is provided. A first radio component is configured to have a correct address of a second radio component, thus forming a first communications link between the first radio component and the second radio component via a packetized switch therebetween. The second radio component is configured to have a correct address of the first radio component, thus forming a second communications link between the second radio component and the first radio component via the packetized switch. Operation of the software radio, including the first radio component and the second radio component, is started.

In a third aspect of the invention, a system is provided. The system includes a group of means for implementing separate portions of a software radio and means for providing packetized switched communications among the group of means for implementing separate portions of a software radio. Some of the group of means for implementing separate portions of a software radio are connected to at least some other of the group of means for implementing separate portions of a software radio via the means for providing packetized switched communications, such that a collection of connected ones of the group of means for implementing separate portions of a software radio forms a complete software radio.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a high level schematic of an exemplary software radio;

FIG. 2 illustrates an implementation of a “radio room” with software radios;

FIG. 3 shows an exemplary implementation consistent with the principles of the invention;

FIG. 4 is a simplified diagram of an exemplary software radio component;

FIG. 5 is a simplified diagram of an exemplary management station; and

FIG. 6 is a flowchart of an exemplary process for implementing aspects of the invention.

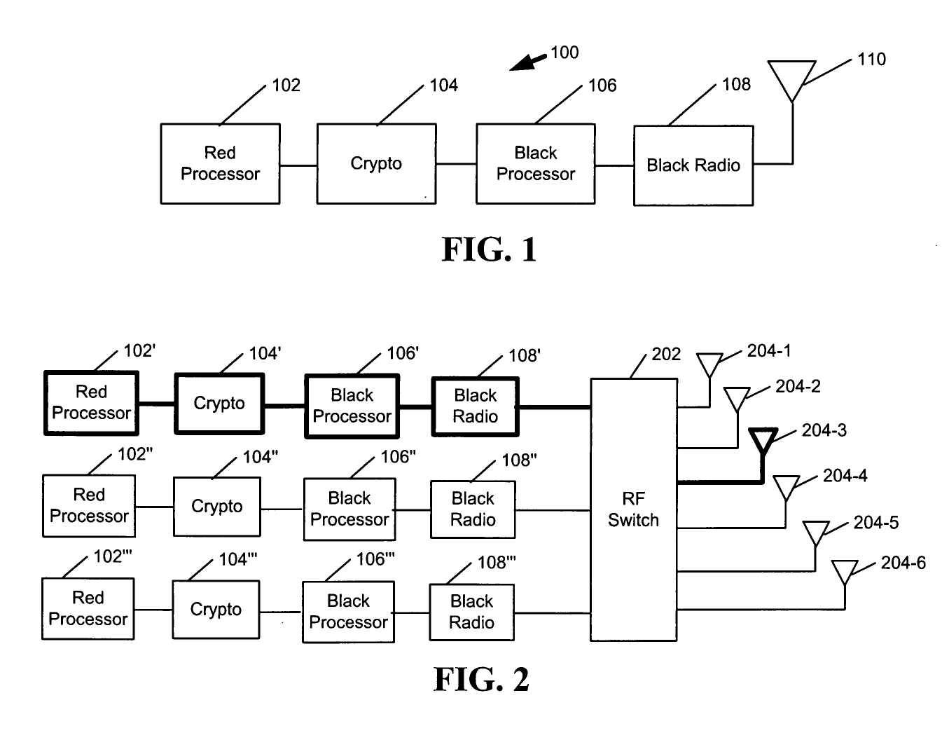

### DETAILED DESCRIPTION

The following detailed description of the invention refers to the accompanying drawings. The same reference numbers in different drawings may identify the same or similar elements. The following detailed description does not limit the invention. Instead, the scope of the invention is defined by the appended claims and equivalents.

### Overview

In implementations consistent with the principles of the invention, red processor 102, crypto 104, black processor 106 and black radio 108 may be connected to one another via an internal packet network, such as an Ethernet network, an Asynchronous Transfer Mode (ATM) switch, a token ring network, a resilient packet ring network, serial links, and the like.

It may be beneficial to organize groups of related radio equipment into a common subsystem, for example, a High Frequency (HF) subsystem, a narrow-band VHF, UHF, and L-band (V/U/L NB) subsystem, a broadband VHF, UHF, L-band (V/U/L BB) subsystem or a UHF subsystem. The specific radio equipment in such a subsystem (such as antennas, power amplifiers, cosite filters, etc.) may then be tailored for that particular frequency band or transmission requirement. Each specific subsystem may be further furnished with one or more black processors to form a complete “component.”

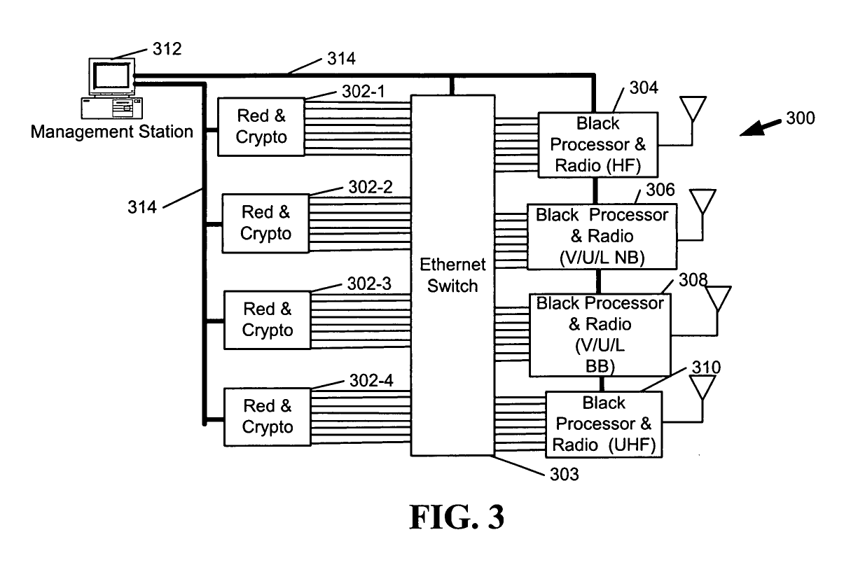

FIG. 3 illustrates an exemplary implementation of a system 300 consistent with principles of the invention. Red processor and crypto components 302-1, 302-2, 302-3, and 302-4 may be connected to a packetized switch, for example, Ethernet switch 303, which may further be connected to black processor and black radio components, such as HF component 304, V/U/L NB component 306, V/U/L BB component 308 and UHF component 310. Other black processor and radio components may be possible, such as Link-16 used by the U.S. military.

Red processor and crypto components 302-1, 302-2, 302-3 and 302-4 may be a combination of red processor component 102 and crypto component 104. Black processor and black radio components 304-310 may be a combination of black processor component 106 and black radio component 108. Further, a black processor and radio component may include shared equipment, such as an RF switch. Such an RF switch may be a small RF switch for a few radios and would be considerably cheaper and experience less data loss than large RF switch 202 (FIG. 2).

Exemplary system 300 may also include a management station 312, which may connect to components 302-1, 302-2, 302-3, 302-4, 304, 306, 308 and 310 or may connect to these components via Ethernet switch 303. Management station 312 may be colocated with the software radio components or may be remotely located. A single management station 312 may monitor and control both the red and black sides of a software radio, or only a single side. Management stations may be replicated as desired. Management station 312 may monitor and/or control operation of the components via existing protocols, including, but not limited to Simple Network Management Protocol (SNMP), Hypertext Transport Protocol (HTTP), Extensible Markup Language (XML), and Common Object Resource Broker Architecture (CORBA). For example, management station 312 may use an existing protocol, such as SNMP, to monitor a status of at least one of the components connected to Ethernet switch 303.

Exemplary system 300 has four red processor and crypto components 302 and four black processor and black radio components 304-310. In other implementations there may be more, fewer, or different components than illustrated in FIG. 3. For example, Ethernet switch 303 may be replicated or implemented as a network of interconnected switches. Further, a switch other than an Ethernet switch may be used in other implementations. For example, system 300 may, instead, include an Asynchronous Transfer Mode (ATM) switch, an Internet Protocol (IP) router or any other type of packetized switch. Further, Ethernet network 314 may also be any type of packet network. Further, no management station 312 or any number of management stations 312 may be included in various implementations of the invention. In addition, Ethernet switch 303 may connect any two components of a software radio. For example, the switch may connect red processor component 102 to crypto component 104 or may connect crypto component 104 to black radio component 108. In commercial implementations not requiring encryption, Ethernet switch 303 may connect red processor component 102 to black processor component 106.

In implementing software radio system 300, each component or module may be attached to a packet network and may thus have a unique address on the network, e.g., modules on an Ethernet may have Internet Protocol (IP) addresses or standard IEEE 802.2 addresses, i.e., Ethernet Media Access Control addresses and, alternatively, modules on an ATM based network may employ ATM addresses.

First, the network addresses may be assigned to modules or components as they power on via standard network protocols, such as DHCP, BOOTP, etc. Software to accomplish this function is well known and widely available, and may simply be installed on the software radio components.

Second, “software download and install” functions may be implemented by standard network protocols. For example, a new module or component may: (a) acquire its network address via Dynamic Host Configuration Protocol (DHCP); (b) find how it may be configured by performing a Domain Name System (DNS) lookup and communicating with a configuration server; and then (c) use a Trivial File Transfer Protocol (TFTP) to download the appropriate software image into its onboard flash memory. Continuing with this example, the new module may learn that it may emulate an FM radio, may then retrieve the appropriate software application and may then save the application in its local flash memory for subsequent execution.

Third, “monitor and control” functions may be implemented via SNMP, HTTP, XML, CORBA, or any other convenient management protocol. For example, management station 312 may configure an address of a software radio component via the SNMP protocol.

### Software Radio Components

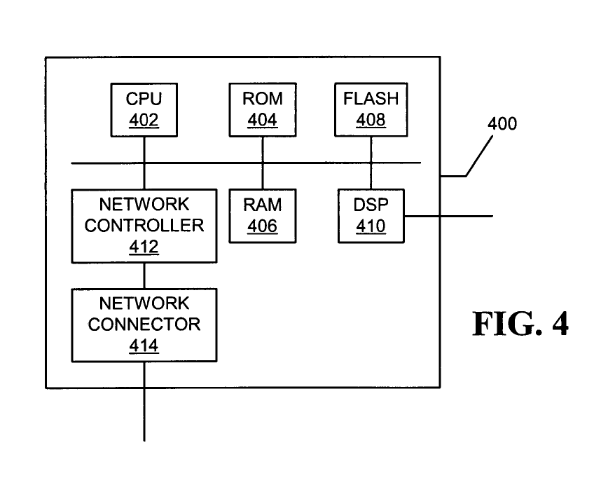

FIG. 4 is a simplified diagram of an exemplary software radio component 400. Software radio component 400 may be used to implement various components. For example, one or more software radio components 400 may be used to implement each of red processor 102, black processor 106, red processor and crypto component 302, HF component 304, V/U/L NB component 306, V/U/L BB component 308 and UHF component 310

Software radio component 400 may include at least one CPU 402, with associated Read Only Memory (ROM) 404, Random Access Memory (RAM) 406, flash memory 408 and Digital Signal Processing (DSP) unit 410, such that software radio component 400 may perform its function through software operating on components 402, 404, 406, 408 and 410. DSP 410 may provide the actual interface between software radio component 400 and a physical radio subunit, such as a Radio Frequency (RF) module that may interface to an antenna, or a Human/Computer Interface (HCI) module that may interface to a speaker, etc.

Software radio component 400 may further include at least one network controller 412 and at least one network connector 414. Network controller 412 and network connector 414 may operate in the manner of known packet network controllers and connectors to provide packet network connectivity between software radio components, management station 312 and modules using standard network protocols, as will be described in further detail below. The protocols may include those of the Internet Protocol (IP) suite, such as IP, User Datagram Protocol (UDP), Transmission Control Protocol (TCP), RealTime Protocol (RTP), Dynamic Host Configuration Protocol (DHCP), Bootstrap Protocol (BOOTP), File Transfer Protocol (FTP), Trivial File Transfer Protocol (TFTP), Domain Name System (DNS) and the like, and may further include various versions of the IP suite, such as IPv4 and IPv6. Additional protocols, such as the Institute of Electrical and Electronic Engineers (IEEE) 802.* set of network standards for link-layer protocols, e.g., frame formats, addresses, etc., may also be used. Further, network controller 412 and network connector 414 may provide connectivity to a packet switch, such as Ethernet switch 303.

### Management Station

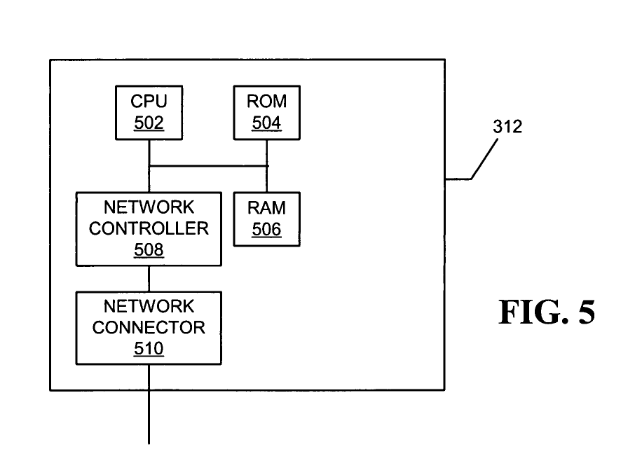

FIG. 5 is a simplified diagram of exemplary management station 312. Management station 312 may include a processor or central processing unit (CPU) 502, storage, such as a Read Only Memory (ROM) 504, Random Access Memory (RAM) 506, network controller 508 and network connector 510. ROM 504 may include instructions or static data for CPU 502. RAM 504 may include instructions or dynamic data for CPU 502. Network controller 508 and network connector 506 may operate in the manner of known packet network controllers and connectors to provide packet network connectivity to the software radio components 302-1, 302-2, 302-3, 302-4, 304, 306, 308 and 310 and switch 303 using standard network protocols.

### Process for Connecting Software Radio Components

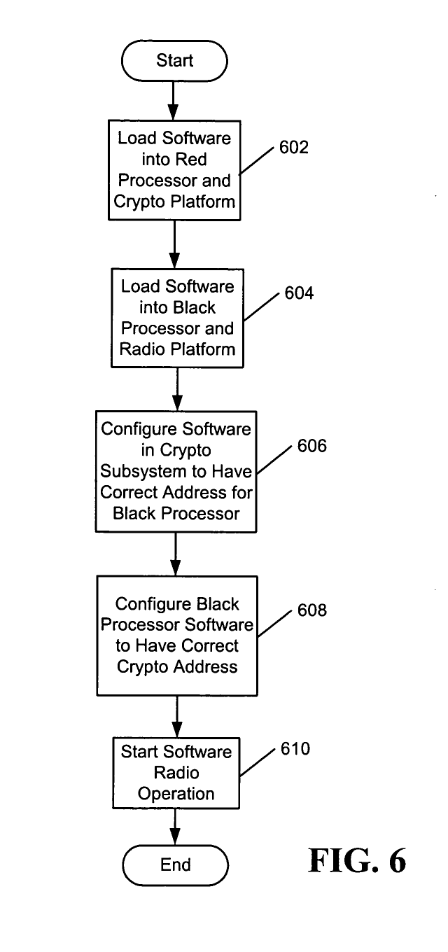

FIG. 6 is a flowchart that illustrates a process for connecting software radio components according to an implementation consistent with the principles of the invention. Red processor and crypto components 302 may determine their configuration and request configured software using methods described above. For example, at power on red processor and crypto components 302 may acquire their network addresses (Ethernet address, IP address, port or any other type of address) via DHCP, determine their configuration by performing a DNS lookup, communicate with a configuration server and then use TFTP to download the appropriate software images. At act 602, the requested software is then loaded into red processor and crypto components 302. Black processor and black radio components 304, 306, 308, and 310 may determine their configuration and request configured software in a manner similar to red processor and crypto components 302. At act 604, the requested software is then loaded into black processor and black radio components 304, 306, 308, and 310.

At act 606, a red processor and crypto component 302 configures its crypto portion to have a correct address for the black processor portion of a black processor and black radio component 304, 306, 308, or 310. This may be accomplished by red processor and crypto component 302 accessing a table in memory, which may have been included in the downloaded software image, and to find an address of a black processor and radio component 304, 306, 308 or 310 to which it is to be connected. Alternatively, management station 312 using a protocol, such as, the SNMP protocol, may configure the red processor and crypto component 302 to have a correct address of a black processor and black radio component 304, 306, 308 or 310 to which it is to connect.

In a manner similar to red processor and crypto component 302 in act 606, at act 608, a black processor and black radio component 304, 306, 308 or 310 may be configured to have a correct address of a red processor and crypto component 302 to which it is to connect. Alternatively, this may be accomplished via management station 312 using a protocol, such as, the SNMP protocol, to configure the black processor and radio component 304, 306, 308 or 310. Using the addresses of red processor and crypto component 302 and black processor and black radio component 304, 306, 308 or 310, a path through Ethernet switch 303 may be established in each direction between the two components. At act 610, once the paths have been established, management station 312 may issue a command to the two components to start radio operation. Alternatively, each component may automatically enter a ready state with radio operation starting after all connected components of a software radio determine that all other software components of the software radio are in the ready state.

In FIG. 6, an exemplary process for a component, such as red processor and crypto component 302 and black processor and black radio component 304, 306, 308 or 310 was explained with regard to the components determining their configuration, downloading the proper software image and configuring themselves to communicate with one other component. The above process is not limited only to red processor and crypto component 302 and black processor and radio component 304, 306, 308 and 310, but instead may apply to communication between any two components. For example, using the method described with reference to FIG. 6, red processor 102 and black processor 106 each may download the appropriate software image and determine the address (Ethernet address, IP address, port or any other type of address) of the component to which they are to be connected. Alternatively, management station 312 may be used to issue commands to each of red processor component 102 and black processor component 106 to provide connecting addresses to each of the components.

### CONCLUSION

Methods and systems consistent with the principles of the invention provide systems and methods for connecting components of software radios.

The foregoing description of preferred embodiments of the invention provides illustration and description, but is not intended to be exhaustive or to limit the invention to the precise form disclosed. Modifications and variations are possible in light of the above teachings or may be acquired from practice of the invention for example, while a series of acts has been described with regard to FIG. 6, the order of the acts may differ in other implementations consistent with the present invention. Also, non-dependent acts may be performed in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

1. A system comprising:
a plurality of radio components; and
a packetized switch, configured to connect some of the radio components to at least some other of the radio components, such that a collection of connected ones of the radio components forms a complete software radio.

2. The system of claim 1, wherein the packetized switch includes one of an Ethernet switch, an Asynchronous Transfer Mode switch, and an Internet Protocol router.

3. The system of claim 1, wherein:
a plurality of first ones of the radio components each include a red processor portion and a crypto portion,
a plurality of second ones of the radio components each include a black processor portion and a black radio portion, and
at least one of the first ones of the radio components are connected to at least one of the second ones of the radio components via the packetized switch.

4. The system of claim 1, wherein:
a plurality of first ones of the radio components each include a crypto portion,
a plurality of second ones of the radio components each include a black radio portion, and
at least one of the first ones of the radio components are connected to at least one of the second ones of the radio components via the packetized switch.

5. The system of claim 1, wherein:
a plurality of first ones of the radio components each include a red processor portion,
a plurality of second ones of the radio components each include a crypto portion, and
at least one of the first ones of the radio components are connected to at least one of the second ones of the radio components via the packetized switch.

6. The system of claim 1, wherein:
a plurality of first ones of the radio components each include a red processor portion,
a plurality of second ones of the radio components each include a black processor portion, and
at least one of the first ones of the radio components are connected to at least one of the second ones of the radio components via the packetized switch.

7. The system of claim 1, wherein the packetized switch includes one of an Ethernet switch, an Asynchronous Transfer Mode switch, and an Internet Protocol router.

8. The system of claim 1, further comprising at least one management station configured to communicate via the packetized switch to at least one of the radio components, the at least one management station is further configured to monitor or control the at least one of the radio components.

9. The system of claim 8, wherein the at least one management station is located remotely from the at least some of the radio components connected to the packetized switch.

10. The system of claim 1, further comprising a management station configured to communicate via a network to at least one of the radio components, the management station is further configured to monitor or control the at least one of the radio components.

11. The system of claim 10, wherein the management station is further configured to provide the at least one of the radio components with an address for connections via the packetized switch.

12. The system of claim 10, wherein the management station is further configured to monitor a status of the at least some of the radio components.

13. A method of connecting components of a software radio, the method comprising:
configuring a first radio component to have a correct address of a second radio component, thus forming a first communications link between the first radio component and the second radio component via a packetized switch therebetween;
configuring the second radio component to have a correct address of the first software radio component, thus forming a second communications link between the second radio component and the first radio component via the packetized switch; and
starting operation of the software radio including the first radio component and the second radio component.

14. The method of claim 13, wherein the packetized switch includes one of an Ethernet switch, an Asynchronous Transfer Mode switch, and an Internet Protocol router.

15. The method of claim 13, wherein:
the first radio component includes a red processor portion and a crypto portion, and
the second radio component includes a black processor portion and a black radio portion.

16. The method of claim 13, wherein:
the first radio component includes a red processor portion, and
the second radio component includes a black processor portion.

17. The method of claim 13, wherein:
the first radio component includes a crypto portion, and
the second radio component includes a black radio portion.

18. The method of claim 13, wherein:
the first radio component includes a red processor portion, and
the second radio component includes a crypto portion.

19. The method of claim 13, further comprising using a management station to communicate via the packetized switch and monitor or control at least one of the radio components.

20. The method of claim 19, further comprising using the management station to configure the at least one of the radio components.

21. The method of claim 19, wherein the management station is located remotely from the at least one of the radio components.

22. The method of claim 13, further comprising using a management station to communicate with a radio component via a network connection with the radio component.

23. A system comprising:
a plurality of means for implementing separate portions of a software radio; and
means for providing packetized switched communications among the plurality of means for implementing separate portions of a software radio,
wherein some of the plurality of means for implementing separate portions of a software radio are connected to at least some other of the plurality of means for implementing separate portions of a software radio via the means for providing packetized switched communications, such that a collection of connected ones of the plurality of means for implementing separate portions of a software radio forms a complete software radio.
